(19) United States
(12) Patent Application Publication
(10) Pub. No.: US 2025/0124638 A1
(43) Pub. Date: Apr. 17, 2025

(54) AVATAR CONTROL DEVICE, AND AVATAR CONTROL METHOD

(71) Applicant: JVCKENWOOD Corporation, Kanagawa (JP)

(72) Inventors: Shunsuke YAMAMOTO, Kanagawa (JP); Aiko TAKIWAKI, Kanagawa (JP); Moe FUJISHIMA, Kanagawa (JP); Yuichi MATSUMOTO, Kanagawa (JP); Hyungjun KIM, Kanagawa (JP); Yu HAYASHISHITA, Kanagawa (JP); Yukako SATO, Kanagawa (JP); Kazuya SEKI, Kanagawa (JP); Minoru SHIGA, Kanagawa (JP)

(21) Appl. No.: 19/002,541

(22) Filed: Dec. 26, 2024

Related U.S. Application Data
(63) Continuation of application No. PCT/JP2023/023224, filed on Jun. 22, 2023.

(30) Foreign Application Priority Data
Jul. 7, 2022 (JP) 2022-109720

(51) Int. Cl. G06T 13/40; G06V 40/16

(52) U.S. Cl. CPC G06T 13/40; G06V 40/165; G06V 40/171

(57) ABSTRACT

An avatar control device for controlling an avatar to be displayed within a virtual space acquires a face image of a user captured by a camera, acquires initial setting information indicating a reference posture of a face of the user, acquires posture information indicating a posture of the face of the user for the camera on the basis of the face image, and controls forward or backward movement of the avatar within the virtual space on the basis of a distance between the camera and the face of the user indicated in the initial setting information and the posture information; and controls a movement direction of the avatar within the virtual space on the basis of an orientation of the face of the user for the camera.

The present invention relates to an avatar control device, and an avatar control method.

### CROSS REFERENCE TO RELATED APPLICATION

Priority is claimed on Japanese Patent Application No. 2022-109720, the content of which is incorporated herein by reference.

### BACKGROUND ART

Conventionally, technology for manipulating avatars, which are the alter egos of users, within a metaverse (a virtual space) has been proposed. For example, technology for detecting a manipulation of a user by attaching a head-mounted device to the user has been proposed (see, for example, Patent Document 1)

### CITATION LIST

### Patent Document

Patent Document 1: Japanese Unexamined Patent Application, First Publication No. 2017-144038

### SUMMARY

### Technical Problem

However, as in the above-described conventional technology, a process of attaching a manipulation detection device (e.g., a head-mounted device) to the body or manipulating the controller while holding the controller by hand is inconvenient for the user.

The present disclosure has been made in view of such a situation, and an objective of the present disclosure is to provide an avatar control device, and an avatar control method for enabling inconvenience for users who manipulate avatars within a metaverse to be reduced.

### Solution to Problem

According to an aspect of the present disclosure, there is provided An avatar control device for controlling an avatar to be displayed within a virtual space, wherein the avatar control device acquires a face image of a user captured by a camera; acquires initial setting information indicating a reference posture of a face of the user; acquires posture information indicating a posture of the face of the user for the camera on the basis of the face image; controls forward or backward movement of the avatar within the virtual space on the basis of a distance between the camera and the face of the user indicated in the initial setting information and the posture information; and controls a movement direction of the avatar within the virtual space on the basis of an orientation of the face of the user for the camera.

According to an aspect of the present disclosure, there is provided an avatar control device for controlling an avatar displayed as an alter ego of a user within a virtual space, wherein the avatar control device acquires a face image that is an image of a face of the user who visually recognizes an image of the virtual space displayed on a display unit, the image being captured by a camera; acquires initial setting information indicating a reference posture of the face of the user; acquires posture information indicating a posture of the face of the user for the camera on the basis of the face image; and controls lateral movement of the avatar within the virtual space on the basis of a displacement angle from the reference posture of the face of the user indicated in the initial setting information and the posture information; and controls a movement direction of the avatar within the virtual space on the basis of an orientation of the face of the user for the camera.

According to an aspect of the present disclosure, there is provided an avatar control method for controlling an avatar to be displayed within a virtual space, the avatar control method including: acquiring a face image of a user captured by a camera; acquiring initial setting information indicating a reference posture of a face of the user; acquiring posture information indicating a posture of the face of the user for the camera on the basis of the face image; controlling forward or backward movement of the avatar within the virtual space on the basis of a distance between the camera and the face of the user indicated in the initial setting information and the posture information; and controlling a movement direction of the avatar within the virtual space on the basis of an orientation of the face of the user for the camera.

According to the present disclosure, it is possible to reduce inconvenience for users who manipulate avatars within a metaverse (a virtual space)

### BRIEF DESCRIPTION OF DRAWINGS

FIG. 1 A diagram showing an example of a functional configuration of an avatar control system of the present embodiment.

FIG. 2 A diagram showing an example of a configuration of an avatar of the present embodiment.

FIG. 3 A diagram showing an example of a flow of a process in an initial setting mode of the present embodiment.

FIG. 4 A diagram showing an example of a flow of a process in an avatar control mode of the present embodiment.

FIG. 5 A diagram showing an example of a captured image of the present embodiment.

FIG. 6 A diagram showing an example of a face image of the present embodiment.

FIG. 7 A diagram showing an example of feature points of the face image of the present embodiment.

FIG. 8 A diagram showing an example of a relative positional relationship between a user at a reference position and a camera.

FIG. 9 A diagram showing an example of a captured image of a user at a reference position captured by a camera.

FIG. 10 A diagram showing an example of a result of avatar movement control when the user is located at the reference position.

FIG. 11 A diagram showing an example of a relative positional relationship between the user and the camera when a face is shifted forward from the reference position.

FIG. 12 A diagram showing an example of a captured image captured by a camera when the face is shifted forward from the reference position.

FIG. 13 A diagram showing an example of a result of avatar movement control when the face is shifted forward from the reference position.

FIG. 14 A diagram showing an example of a relative positional relationship between the user and the camera when the face is shifted backward from the reference position.

FIG. 15 A diagram showing an example of a captured image captured by a camera when the face is shifted backward from the reference position.

FIG. 16 A diagram showing an example of a result of movement control of the avatar when the face is shifted backward from the reference position.

FIG. 17 A diagram showing an example of the relative positional relationship between the user at the reference position and the camera.

FIG. 18 A diagram showing an example of a captured image of the user at the reference position captured by the camera.

FIG. 19 A diagram showing an example of a result of avatar movement control when the user is at the reference position.

FIG. 20 A diagram showing an example of a relative positional relationship between the user and the camera when the head is rotated in a left direction.

FIG. 21 A diagram showing an example of a captured image of the user whose head has been rotated in the left direction captured by the camera.

FIG. 22 A diagram showing an example of a result of avatar movement control when the head is rotated in the left direction.

FIG. 23 A diagram showing an example of a relative positional relationship between the user and the camera when the head is rotated in a right direction.

FIG. 24 A diagram showing an example of a captured image of the user whose head is rotated in the right direction captured by the camera.

FIG. 25 A diagram showing an example of a result of avatar movement control when the head is rotated in the right direction.

FIG. 26 A diagram showing an example of control switching based on a magnitude of a change in a distance between feature points.

FIG. 27 A diagram showing an example of a captured image of the user whose head is tilted in the right direction captured by the camera.

FIG. 28 A diagram showing an example of a result of avatar movement control when the head is tilted in the right direction.

FIG. 29 A diagram showing an example of a captured image 50 of the user whose head is tilted in the left direction captured by the camera.

FIG. 30 A diagram showing an example of a result of avatar movement control when the head is tilted in the left direction.

FIG. 31 A diagram showing an example of a captured image of the user who has moved in the left direction captured by the camera.

FIG. 32 A diagram showing an example of a captured image of the user who has moved in the right direction captured by the camera.

### DETAILED DESCRIPTION

Hereinafter, embodiments of the present disclosure will be described with reference to the drawings. The embodiments to be described below are only examples and embodiments to which the present disclosure is applied are not limited to the following embodiments.

### [Functional Configuration of Avatar Control System 1]

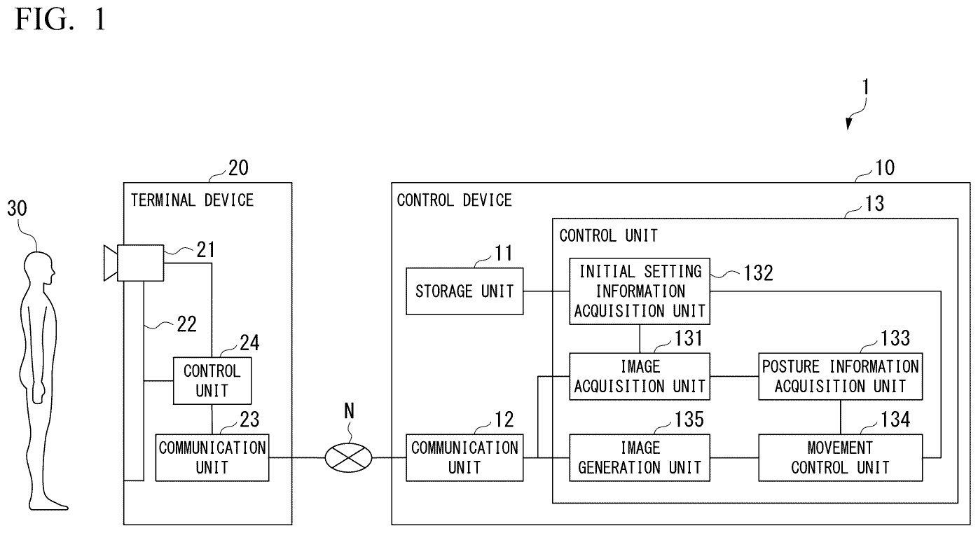

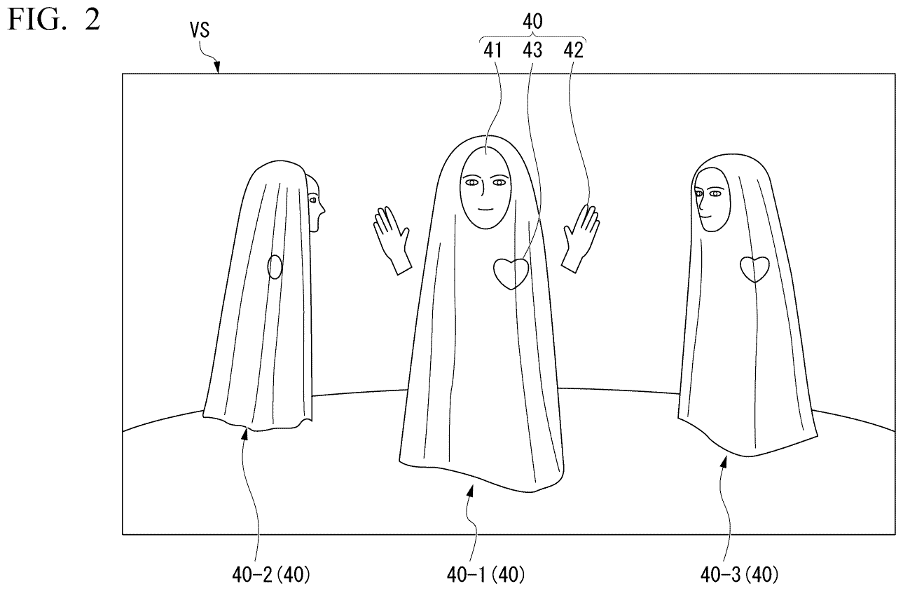

FIG. 1 is a diagram showing an example of a functional configuration of an avatar control system 1 of the present embodiment. In the avatar control system 1, a control device (an avatar control device) and a terminal device 20 perform two-way communication via a network N and therefore a user 30 controls an avatar 40 within a virtual space VS. An example of a configuration of the avatar 40 will be described with reference to FIG. 2.

### [Configuration of Avatar 40]

FIG. 2 is a diagram showing an example of a configuration of the avatar 40 of the present embodiment. The avatar 40 includes a face part 41, hand parts 42, and a state display part 43.

The face part 41 is generated on the basis of on an image (i.e., a face image 51) obtained by capturing a face of the user 30 (Capturing is also referred to as imaging. The same is true for the following description). The face part 41 is arranged on a front plane of the avatar 40 and represents an orientation of the avatar 40 within a virtual space VS. A facial expression of the avatar 40 indicated by the face part 41 may be updated in real time according to a change in the facial expression of the user 30.

The hand parts 42 are arranged on the left and right sides of the avatar 40 and function as virtual hands of the avatar 40. For example, the hand part 42 has a function such as touching a virtual object or another avatar 40 arranged within the virtual space VS. In addition, the hand part 42 may be displayed when necessary and may not be displayed all the time.

The state display part 43 is a virtual part indicating a state of the avatar 40. The state display part 43, for example, expresses the state of the avatar 40 (e.g., a psychological state such as happy or sad) according to a change in shape or color. The state display part 43 may change in conjunction with a state (e.g., the psychological state) of the user 30 who manipulates the avatar 40.

As shown in FIG. 2, the shape of the avatar may be any shape as long as the orientation of the avatar can be recognized by the face part 41. For example, the shape of the avatar may be a shape that resembles a human body. The shape of the avatar may be selectable by the user 30, and the image of the user captured by the camera 21 to be described below (e.g., the face image 51) may be reflected in the face part 41.

The avatar 40 is displayed within the virtual space VS as an alter ego of the user 30. The avatar 40 moves within the virtual space VS on the basis of the control of the control device 10. When a plurality of users 30 are using the avatar control system 1, a plurality of avatars 40 corresponding to the users 30 are arranged within the virtual space VS. In an example of FIG. 2, an avatar 40-1 which is the avatar 40 of a first user (a user 30-1), an avatar 40-2 which is the avatar 40 of a second user (a user 30-2), and an avatar 40-3 which is the avatar 40 of a third user (a user 30-3) are arranged within the virtual space VS.

In the following description, when the plurality of users 30-1 to 30-3 are not distinguished, they are collectively referred to as a user 30. Moreover, when the plurality of avatars 40-1 to 40-3 are not distinguished, they are collectively referred to as the avatar 40.

A configuration of the avatar control system 1 will continue to be described with reference back to FIG. 1. The avatar control system 1 includes a function (i.e., a face tracking function) of controlling the movement of the avatar 40 within the virtual space VS in accordance with the movement of the face of the user 30. The control device 10 and the terminal device 20 include a configuration for implementing the face tracking function.

The terminal device 20 is, for example, a computer device such as a smartphone or a personal computer, and includes a camera 21, a display unit 22, a communication unit 23, and a control unit 24.

The control unit 24 includes, for example, an arithmetic function of a central processing unit (CPU) or the like, and controls each part of the terminal device 20.

The communication unit 23 includes a communication circuit, and performs information communication with the control device 10 via the network N on the basis of the control of the control unit 24.

The display unit 22 includes, for example, a liquid crystal display, and displays an image on the basis of the control of the control unit 24.

In an example of the present embodiment, information indicating the state of the virtual space VS described above is transmitted from the control device 10 to the terminal device 20. When the communication unit 23 receives information indicating the state of the virtual space VS from the control device 10, the control unit 24 causes the display unit 22 to display an image indicating the state of the virtual space VS. The display unit 22 displays the state of the virtual space VS.

The camera 21 captures an image and outputs the captured image to the control unit 24. The camera 21 of the present embodiment is arranged at a position where the face of the user 30 who visually recognizes the image of the virtual space VS displayed on the display unit 22 can be captured. For example, when the terminal device 20 is a smartphone, the camera 21 is arranged on a surface identical to a surface on which the display unit 22 is arranged as a so-called in-camera.

In the following description, the image of the face of the user 30 captured by the camera 21 is also referred to as the face image 51. That is, the face image 51 is an image in which the face of the user 30 who visually recognizes an image of the virtual space VS displayed on the display unit 22 is captured by the camera 21.

The control unit 24 transmits the face image 51 captured by the camera 21 to the control device 10 via the communication unit 23.

The control device 10 is, for example, a server computer device, and includes a storage unit 11, a communication unit 12, and a control unit 13.

The control unit 13 includes, for example, an arithmetic function such as a central processing unit (CPU), and controls each part of the control device 10.

The storage unit 11 includes a storage device such as a semiconductor memory and stores various types of information.

The communication unit 12 includes a communication circuit and performs information communication with the terminal device 20 via the network N on the basis of the control of the control unit 13.

### [Regarding Operation Mode of Control Unit]

The control unit 13 has two types of operation modes, i.e., “initial setting mode” and “avatar control mode.”

The initial setting mode is an operation mode in which information indicating a reference posture of the face of the user 30 (initial setting information) is stored in the storage unit 11 on the basis of the face image 51 of the user 30.

The avatar control mode is an operation mode in which the avatar 40 within the virtual space VS is moved by the face tracking function. In the avatar control mode, the control unit 13 causes the avatar 40 within the virtual space VS to move in accordance with manipulation content of the user 30 by determining the manipulation content of the user 30 on the basis of the initial setting information stored in the storage unit 11 (i.e., a reference posture of the face of the user 30) and the face image 51 captured in the terminal device 20. Details of the functional configuration of the control unit 13 will be described. In addition, in the following description, controlling a position, movement direction, movement speed, or the like of the avatar 40 within the virtual space VS is simply referred to as controlling the avatar 40 or moving the avatar 40.

### [Functional Configuration of Control Unit]

The control unit 13 of the present embodiment includes an image acquisition unit 131, an initial setting information acquisition unit 132, a posture information acquisition unit 133, a movement control unit 134, and an image generation unit 135 as a software function unit or a hardware function unit.

The image acquisition unit 131 acquires the face image 51 of the user 30 transmitted by the terminal device 20. As described above, the face image 51 is an image in which the face of the user 30 who visually recognizes an image of the virtual space VS displayed on the display unit 22 is captured by the camera 21.

In the initial setting mode, the image acquisition unit 131 outputs the face image 51, which has been acquired, to the initial setting information acquisition unit 132.

The initial setting information acquisition unit 132 acquires a reference posture of the face of the user 30 on the basis of the face image 51 output by the image acquisition unit 131. For example, the initial setting information acquisition unit 132 acquires a reference direction of the face of the user 30, a distance between reference feature points of the face of the user 30, and the like, which will be described below, as information indicating the reference posture of the user 30. The initial setting information acquisition unit 132 causes the reference posture, which is obtained from the reference direction of the face of the user 30, the distance between the reference feature points of the face of the user 30, and the like, as initial setting information, to be stored in the storage unit 11.

In the avatar control mode, the initial setting information acquisition unit 132 acquires the initial setting information stored in the storage unit 11. That is, the initial setting information acquisition unit 132 acquires the initial setting information indicating the reference posture of the face of the user 30.

The image acquisition unit 131 outputs the acquired face image 51 to the posture information acquisition unit 133.

The posture information acquisition unit 133 determines a posture of the face of the user 30 for the camera 21 on the basis of the face image 51. The posture information acquisition unit 133 acquires a result of determining the posture of the face of the user 30 as posture information. That is, the posture information acquisition unit 133 acquires the posture information indicating the posture of the face of the user 30 for the camera 21 on the basis of the face image 51.

The movement control unit 134 controls the movement of the avatar 40 within the virtual space VS on the basis of the initial setting information and the posture information. Specifically, the movement control unit 134 compares the position and direction of the face of the user 30 indicated in the posture information with the reference posture of the face of the user 30 indicated in the initial setting information. The movement control unit 134 determines a deviation of the position or direction of the face of the user 30 from the reference posture, which is obtained as a comparison result, as the manipulation content of the user 30. The movement control unit 134 converts the manipulation content of the user into a movement direction or a movement amount of the avatar 40 on the basis of a prescribed rule. The movement control unit 134 outputs the calculated movement direction or movement amount of the avatar 40 to the image generation unit 135.

The image generation unit 135 obtains the direction or position of the avatar 40 within the virtual space VS on the basis of the movement direction or movement amount of the avatar 40 calculated by the movement control unit 134 and generates an image in which the avatar 40 is arranged within the virtual space VS. The image generation unit 135 transmits the generated image to the terminal device 20 via the communication unit 12.

As a result, an image of the avatar 40 corresponding to a manipulation intention of the user 30 is displayed on the display unit 22 of the terminal device 20.

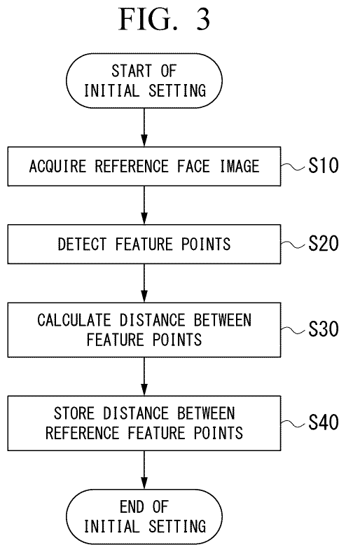

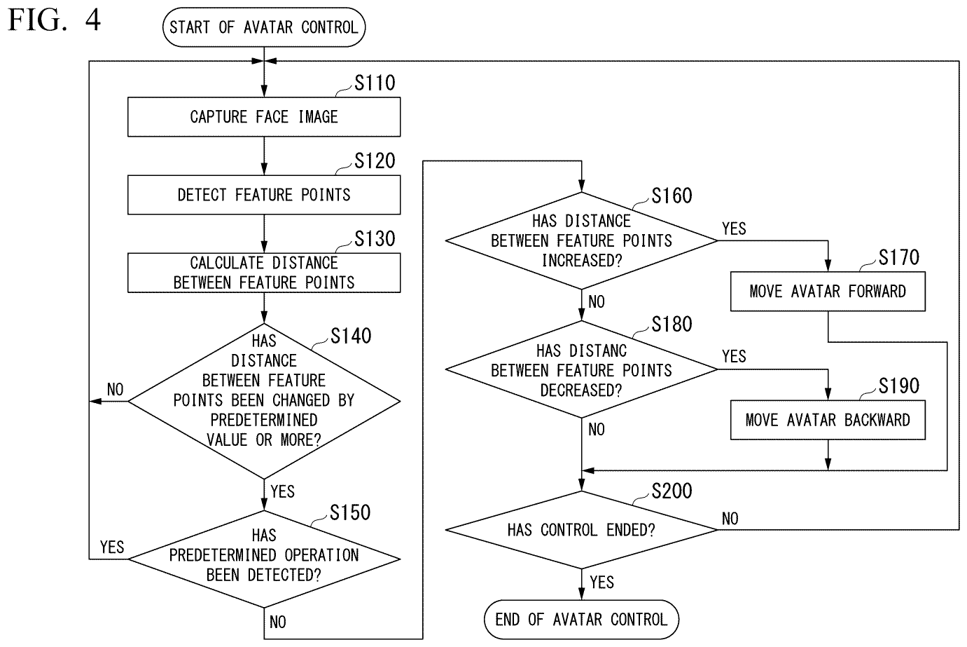

A specific flow of each process in the above-described initial setting mode and the above-described avatar control mode will be described with reference to FIGS. 3 and 4.

### [Flow of Process in Initial Setting Mode]

FIG. 3 is a diagram showing an example of a flow of a process in the initial setting mode of the present embodiment.

(Step S10) The terminal device 20 captures the user 30 with the camera 21.

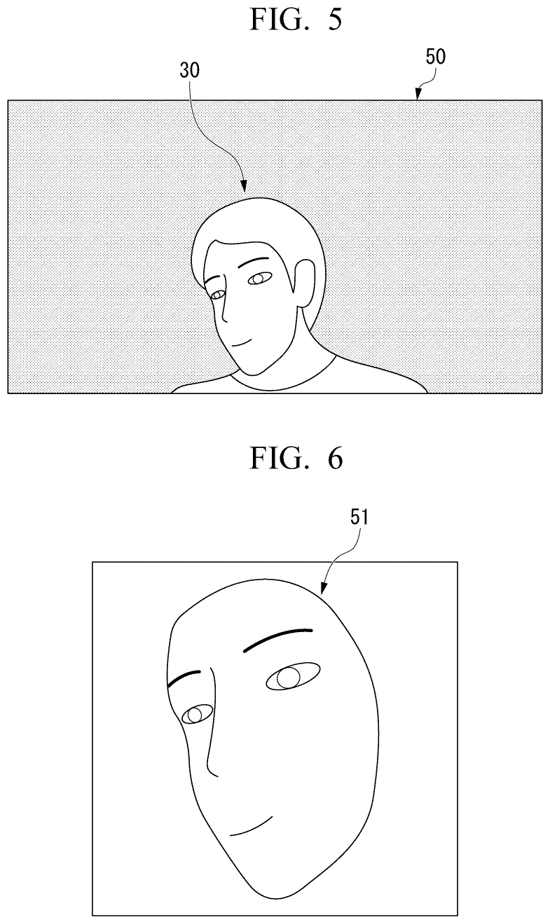

FIG. 5 is a diagram showing an example of the captured image 50 of the present embodiment. The camera 21 captures an area including the face of the user 30 who visually recognizes the display unit 22. The image captured by the camera 21 is also referred to as the captured image 50. The camera 21 outputs the captured image 50 to the control unit 24.

The control unit 24 generates a face image 51 by cutting out a portion of the face of the user 30 from the captured image 50.

FIG. 6 is a diagram showing an example of the face image 51 of the present embodiment. The control unit 24 transmits the face image 51 cut out from the captured image 50 to the control device 10. Here, the face image 51 cut out in the initial setting mode is also referred to as a reference face image. That is, the control unit 24 transmits the reference face image to the control device 10. The image acquisition unit 131 of the control device 10 acquires the reference face image.

(Step S20) Returning to FIG. 3, the initial setting information acquisition unit 132 of the control device 10 detects feature points P included in the face image 51 (i.e., the reference face image) acquired by the image acquisition unit 131 in step S10. The feature point P is a point used to indicate a position or direction of the face of the user 30 among points included in the face image 51. For example, left and right eyes, left and right cheekbones, a chin tip, and the like of the user 30 are included in the feature points P.

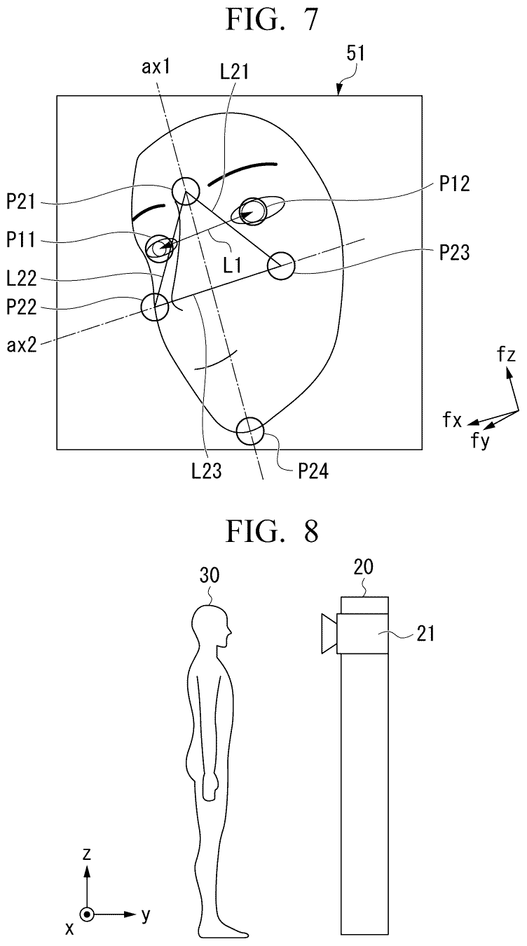

FIG. 7 is a diagram showing an example of the feature points P of the face image 51 of the present embodiment. In this example, the face image 51 includes a feature point P11 (right eye) and a feature point P12 (left eye). The initial setting information acquisition unit 132 detects the feature point P11 and the feature point P12 from the face image 51. The initial setting information acquisition unit 132 calculates a vertical axis ax1 and a horizontal axis ax2 of the face image 51 by setting an axis perpendicular to a line segment connecting the detected two feature points P as the vertical axis ax1 and setting a parallel axis as the horizontal axis ax2.

In addition, the direction of the face image 51 is indicated by a three-dimensional Cartesian coordinate system of face coordinate axes (fx, fy, fz). The face coordinate axis fz is an axis parallel to the vertical axis ax1 and indicates the vertical direction of the face. The face coordinate axis fx is an axis parallel to the horizontal axis ax2 and indicates the left or right direction of the face. The face coordinate axis fy is an axis in the normal direction of the plane formed by the vertical axis ax1 and the horizontal axis ax2 and indicates the forward or backward direction of the face.

The initial setting information acquisition unit 132 calculates a direction of the normal line of the plane (i.e., the face coordinate axis fy) formed by the calculated vertical axis ax1 and the calculated horizontal axis ax2 as the direction of the face of the user 30. The initial setting information acquisition unit 132 determines the calculated face direction as a reference direction.

(Step S30) Returning to FIG. 3, the initial setting information acquisition unit 132 calculates a distance L1 between the feature point P11 and the feature point P12 in the reference face image as a reference length between the feature points P.

The reference length between the feature points P is also referred to as the distance between the reference feature points.

In addition, the feature point P is not limited to only two points, i.e., the feature point P11 (the right eye) and the feature point P12 (the left eye). For example, three points, i.e., a feature point P21 (an area between the eyebrows), a feature point P22 (a right cheekbone), and a feature point P23 (a left cheekbone), may be used as feature points P. That is, the initial setting information acquisition unit 132 may determine a reference direction by detecting a triangle formed by the feature point P21, the feature point P22, and the feature point P23. In this case, the initial setting information acquisition unit 132 calculates the vertical axis ax1 and the horizontal axis ax2 on the basis of the triangle formed by the feature point P21, the feature point P22, and the feature point P23. The initial setting information acquisition unit 132 calculates a direction of a normal line of the plane (i.e., the face coordinate axis fy) formed by the calculated vertical axis ax1 and the calculated horizontal axis ax2 as the direction of the face of the user 30.

Moreover, the initial setting information acquisition unit 132 calculates a distance L22 between the feature point P21 and the feature point P22, a distance L23 between the feature point P22 and the feature point P23, and a distance L21 between the feature point P23 and the feature point P21 in the reference face image as reference lengths between the feature points P (i.e., distances between reference feature points).

(Step S40) The initial setting information acquisition unit 132 causes a reference length between the reference direction of the face of the user 30 calculated in step S20 and the feature point P calculated in step S30, i.e., a distance between the reference feature points, to be stored in the storage unit 11, and ends the process of the initial setting mode. As a result, the storage unit 11 stores the distance between the reference feature points when the face of the user 30 is facing in the reference direction. It is possible to obtain the reference posture of the face of the user 30 by performing geometric arithmetic operations for the reference direction of the face of the user 30 and the distance between the reference feature points. In other words, the initial setting information acquisition unit 132 causes the reference direction of the face of the user 30 and the distance between the reference feature points to be stored in the storage unit 11 as information indicating the reference posture of the face of the user 30.

### [Flow of Process in Avatar Control Mode]

FIG. 4 is a diagram showing an example of a flow of a process in the avatar control mode of the present embodiment.

(Step S110) The terminal device 20 captures the face of the user 30 with the camera 21.

The control unit 24 cuts out a portion of the face of the user 30 from the captured image and generates the face image 51. The control unit 24 transmits the face image 51, which has been generated, to the control device 10.

The image acquisition unit 131 of the control device 10 acquires the face image 51 transmitted by the terminal device 20.

(Step S120) The posture information acquisition unit 133 detects feature points P included in the face image 51 acquired by the image acquisition unit 131.

(Step S130) The posture information acquisition unit 133 calculates a distance between the detected feature points P.

In addition, because a procedure for detecting the feature points P and a procedure for calculating a distance between the feature points P in the posture information acquisition unit 133 are similar to a procedure for detecting the feature points P and a procedure for calculating a distance between the feature points P performed by the initial setting information acquisition unit 132 in the above-described initial setting mode, description thereof will be omitted.

Here, a distance between the feature points P changes with a change in the posture of the user 30 for the camera 21. For example, if the user 30 approaches the camera 21, a proportion of a face area of the user 30 occupied within a range of an angle of view of the camera 21 increases and a distance between the feature points P increases. Moreover, if the user 30 moves away from the camera 21, the distance between the feature points P decreases. That is, the distance between the feature points P functions as posture information indicating the posture of the face of the user 30.

The posture information acquisition unit 133 acquires the distance between the feature points P as the posture information of the user 30.

In other words, the posture information acquisition unit 133 acquires posture information indicating the posture of the face of the user 30 for the camera 21 on the basis of the face image 51.

(Step S140) The posture information acquisition unit 133 determines whether or not the distance between the feature points P calculated in step S130 has been changed by a predetermined value or more. When it is determined that a distance between the feature points P has been changed by the predetermined value or more (step S140; YES), the posture information acquisition unit 133 moves the process to step S150. When it is determined that the distance between the feature points P has not been changed by the predetermined value or more (step S140; NO), the posture information acquisition unit 133 returns the process to step S110.

According to the control device 10 configured as described above, small movements not intended by the user 30 can be excluded from the movement control of the avatar 40.

In addition, the determination of whether or not the distance between the feature points P has been changed by the predetermined value or more may be made by performing the comparison with the distance between the feature points P of the reference face image or by performing the comparison between the face images 51 captured at different timings (e.g., the comparison between a face image 51 several frames ago and a face image 51 of the latest frame).

(Step S150) The posture information acquisition unit 133 determines whether or not a predetermined operation is included in the image captured by the camera 21.

Here, the predetermined operation includes, for example, an operation in which the user 30 closes the eyes for a predetermined time or more, an operation in which the user 30 quickly shakes the face left and right, an operation in which the user 30 approaches the camera 21 at a predetermined distance or less, and the like.

In addition, when the control device 10 receives not only the face image 51 but also the captured image 50 captured by the camera 21 from the terminal device 20, the operation of the user 30 included in the captured image 50 may be a target of a predetermined operation. For example, an operation in which the user 30 covers the face with his or her hands, an operation in which the user 30 spreads his or her hands, an operation in which the user 30 crosses his or her arms or raises his or her hands, and the like may be included in the predetermined operation.

When the posture information acquisition unit 133 determines that the predetermined operation is included in the image captured by the camera 21 (step S150; YES), the posture information acquisition unit 133 returns the process to step S110. When it is determined that the predetermined operation is not included (step S150; NO), the posture information acquisition unit 133 moves the process to step S160.

Here, a process after step S160 is a process related to the movement control of the avatar 40. That is, the posture information acquisition unit 133 determines whether or not to perform movement control of the avatar 40 on the basis of whether or not the user 30 has performed the predetermined operation. The posture information acquisition unit 133 detects the predetermined operation of the user 30 captured by the camera 21 and does not perform the movement control of the avatar 40 when the predetermined operation has been detected. Alternatively, the posture information acquisition unit 133 does not control the movement of the avatar 40 when the predetermined operation continues for a predetermined time or more.

Moreover, the posture information acquisition unit 133 may be configured so that the movement of the avatar 40 is not controlled while the user 30 is performing the predetermined operation.

For example, the predetermined operation of the user 30 is assigned to a control process other than the movement control for the avatar 40, such that the user 30 can select whether to control the movement of the avatar 40 or perform a control process other than the movement control for the avatar 40. According to the control device 10 configured in this way, various types of control can be performed according to the operations of the user 30.

Moreover, the posture information acquisition unit 133 may be configured so that the movement of the avatar 40 is not controlled when the user 30 performs sudden movement. The sudden operation of the user 30 corresponds to, for example, a case where the direction or tilt of the face of the user 30, the distance between the face and the camera 21, or the like is changed by a predetermined threshold value or more within a predetermined time.

### [Avatar Movement Control (Forward or Backward Movement)]

In steps S160 to S190, a specific example of movement control of the avatar 40 will be described.

FIG. 8 is a diagram showing an example of a relative positional relationship between the user 30 at a reference position and the camera 21. The reference position is a position when the reference face image has been captured in the initial setting mode described above.

As shown in FIG. 8, when the user 30 and the camera 21 are facing each other, the position and direction of the face of the user 30 in the real space are indicated by a three-dimensional Cartesian coordinate system of the real space coordinate axes (x, y, z). The real-space coordinate axis z represents the vertical direction of the user 30. The real space coordinate axis x represents the left or right direction of the user 30. The real-space coordinate axis y represents the forward or backward direction of the user 30.

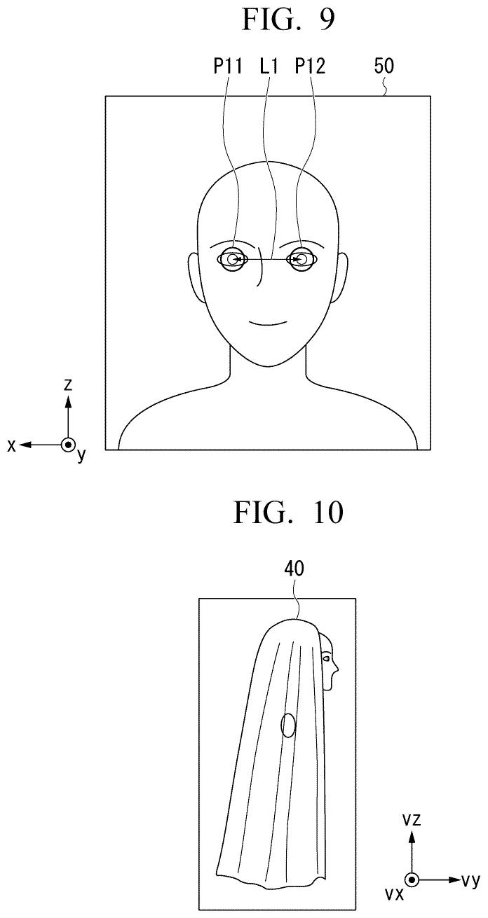

FIG. 9 is a diagram showing an example of a captured image 50 captured by the camera 21 of the user 30 at a reference position. In the captured image 50, the feature point P11 (right eye) and the feature point P12 (left eye) of the face of the user 30 are captured. When the user 30 is at the reference position, a distance between the feature point P11 (right eye) and the feature point P12 (left eye) is a distance L1 (i.e., a distance between the reference feature points).

FIG. 10 is a diagram showing an example of a result of movement control of the avatar 40 when the user 30 is at a reference position. Here, the position and direction of the avatar 40 within the virtual space VS are indicated by a three-dimensional Cartesian coordinate system of the avatar coordinate axes (vx, vy, vz). An avatar coordinate axis vz represents the vertical direction of the avatar 40. The avatar coordinate axis vx represents the left or right direction of the avatar 40. The avatar coordinate axis vy represents the forward or backward direction of the avatar 40.

When the user 30 is at the reference position, the avatar 40 does not move in any direction of the avatar coordinate axes (vx, vy, vz). When the user 30 moves the face to a position shifted from the reference position, the control device 10 moves the avatar 40. A specific example of movement control of the avatar 40 will be described with reference to steps S160 to S190 of FIG. 4.

(Step S160) The posture information acquisition unit 133 controls the movement of the avatar 40 on the basis of the change in the distance between the feature points P calculated in step S130. Specifically, when it is determined that the distance between the feature points P has increased (step S160; YES), the posture information acquisition unit 133 moves the process to step S170. When it is determined that the distance between the feature points P has not increased (step S160; NO), the posture information acquisition unit 133 moves the process to step S180.

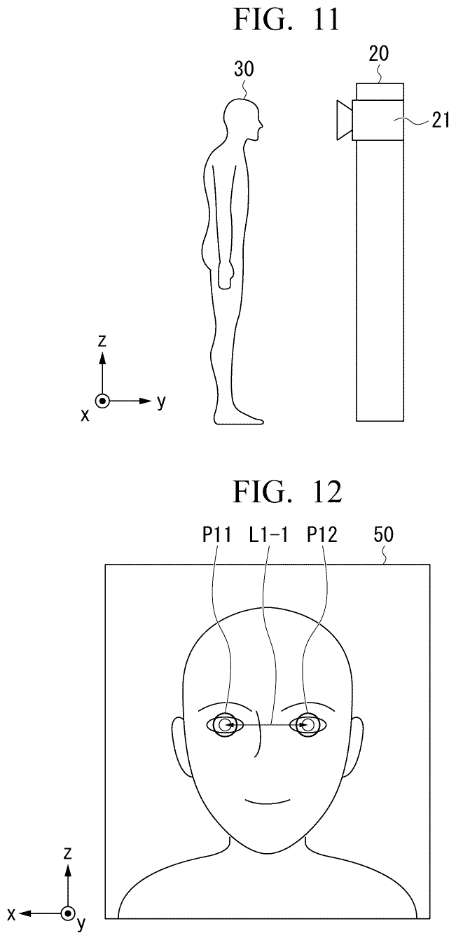

FIG. 11 is a diagram showing an example of a relative positional relationship between the user 30 and the camera 21 when the face is shifted forward from the reference position. When the user 30 shifts the face forward from the reference position (the ty direction), the face of the user 30 is close to the camera 21.

FIG. 12 is a diagram showing an example of a captured image 50 captured by the camera 21 when the face is shifted forward from the reference position. When the face of the user 30 is close to the camera 21, a proportion of a face area of the user 30 occupied at an angle of view of the camera 21 increases. In this case, the distance between the feature point P11 and the feature point P12 of the user 30 becomes a distance L1-1. The distance L1-1 is larger than a distance L1 (i.e., a reference distance) shown in FIG. 9. That is, when the face of the user 30 is close to the camera 21, a distance between the feature point P11 and the feature point P12 of the user 30 increases.

(Step S170) When the distance between the feature points P has increased, the movement control unit 134 moves the avatar 40 forward. The image generation unit 135 generates an image of the avatar 40 moved forward by the movement control unit 134 and transmits the generated image to the terminal device 20.

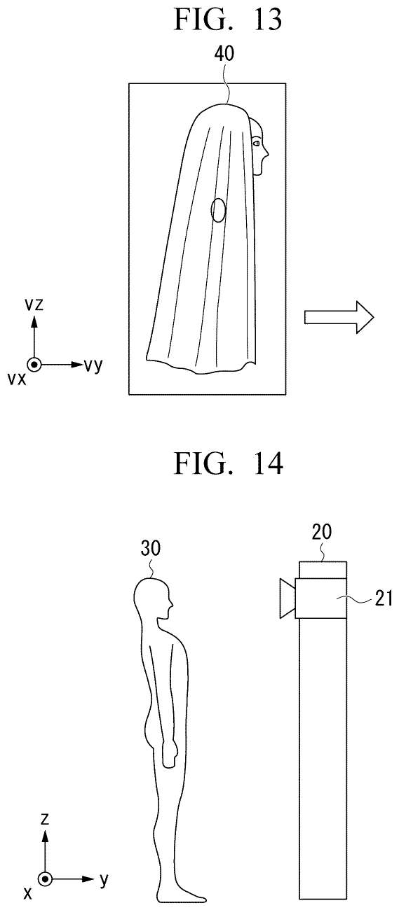

FIG. 13 is a diagram showing an example of a result of movement control of the avatar 40 when the face is shifted forward from the reference position. As shown in FIG. 13, the avatar 40 moves in the + (plus) direction of the avatar coordinate axis vy. That is, when the user 30 brings the face closer to the camera 21, the avatar 40 moves forward.

(Step S180) The posture information acquisition unit 133 controls the movement of the avatar 40 on the basis of a change in the distance between the feature points P calculated in step S130. Specifically, when it determined that the distance between the feature points P has been reduced (step S180; YES), the posture information acquisition unit 133 moves the process to step S190. When it is determined that the distance between the feature points P has not been reduced (step S180; NO), the posture information acquisition unit 133 moves the process to step S200.

FIG. 14 is a diagram showing an example of a relative positional relationship between the user 30 and the camera 21 when the face has been shifted backward from the reference position. When the user 30 has shifted the face backward from the reference position (in the −y direction), the face of the user 30 is away from the camera 21.

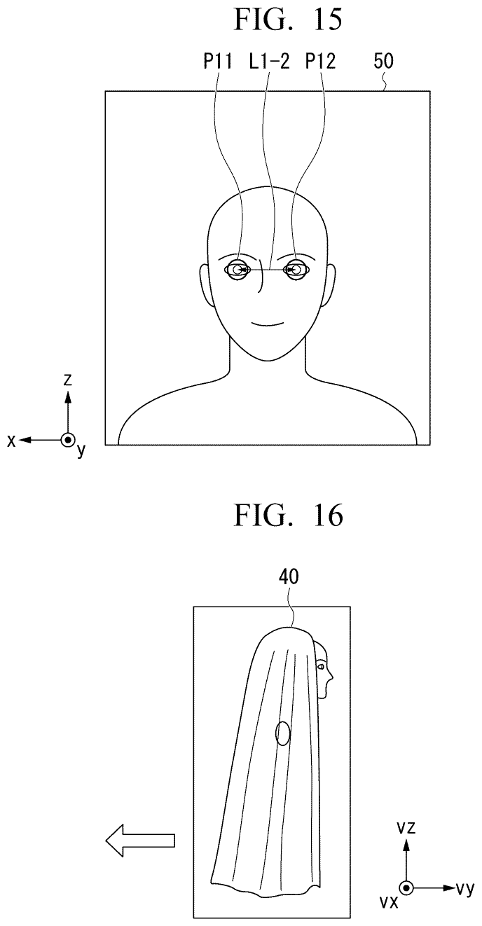

FIG. 15 is a diagram showing an example of a captured image 50 captured by the camera 21 when the face has been shifted backward from the reference position. When the face of the user 30 is away from the camera 21, a proportion of the face area of the user 30 occupied at the angle of view of the camera 21 decreases. In this case, the distance between the feature point P11 and the feature point P12 of the user 30 becomes a distance L1-2. The distance L1-2 is less than the distance L1 (i.e., the reference distance) shown in FIG. 9. That is, when the face of the user 30 is away from the camera 21, the distance between the feature point P11 and the feature point P12 of the user 30 decreases.

(Step S190) When the distance between the feature points P is reduced, the movement control unit 134 causes the avatar 40 to move backward. The image generation unit 135 generates an image of the avatar 40 moved backward by the movement control unit 134 and transmits the generated image to the terminal device 20.

FIG. 16 is a diagram showing an example of a result of movement control of the avatar 40 when the face has been shifted backward from the reference position. As shown in FIG. 16, the avatar 40 moves in the − (minus) direction of the avatar coordinate axis vy. That is, when the user 30 moves his or her face away from the camera 21, the avatar 40 moves backward.

(Step S200) The control unit 13 determines whether or not to end the movement control of the avatar 40. When it is determined that the movement control of the avatar 40 does not end (step S200; NO), the control unit 13 returns the process to step S110. When it is determined that the movement control of the avatar 40 ends (step S200; YES), the control unit 13 ends a series of movement control processing steps for the avatar 40.

In the above-described example, the movement control unit 134 controls forward or backward movement of the avatar 40 on the basis of a reference length between the feature points P indicated in the initial setting information (also referred to as a distance between reference feature points, for example, a distance L1) and distances between the feature points P indicated in the posture information (e.g., a distance L1-1 and a distance L1-2). That is, the movement control unit 134 controls the forward or backward movement of the avatar 40 within the virtual space VS on the basis of a distance between the camera 21 and the face of the user 30.

As described above, the avatar control system 1 controls the movement of the avatar by tracking the face of the user 30. According to the avatar control system 1 configured in this way, the manipulation of the user 30 can be reflected in the movement control of the avatar 40 without the user 30 manipulating the controller or without attaching a headset that detects the manipulation to the user 30.

In addition, the posture information acquisition unit 133 may detect a magnitude of the distance between the camera 21 and the face of the user 30 or a change rate of the distance. In this case, the movement control unit 134 may be configured to control a forward or backward movement velocity or acceleration in accordance with the magnitude of the distance between the camera 21 and the face of the user 30 or the change rate of the distance.

Moreover, the posture information acquisition unit 133 may increase the forward speed of the avatar 40 as the distance between the camera 21 and the face of the user 30 decreases. The posture information acquisition unit 133 may increase the backward speed of the avatar 40 as the distance between the camera 21 and the face of the user 30 increases.

The posture information acquisition unit 133 may continuously change the movement speed of the avatar 40 on the basis of a change in the distance between the camera 21 and the face of the user 30. Moreover, the posture information acquisition unit 133 may divide the distance between the camera 21 and the face of the user 30 into a plurality of predetermined ranges and change the movement speed of the avatar 40 in stages according to the distance between the camera 21 and the face of the user 30.

Although a case where the avatar 40 moves forward when the distance between the camera 21 and the user 30 decreases and the avatar 40 moves backward when the distance between the camera 21 and the user 30 increases, the present disclosure is not limited thereto. For example, the control device 10 may move the avatar 40 backward when the distance between the camera 21 and the user 30 decreases and may move the avatar 40 forward when the distance between the camera 21 and the user 30 increases.

Moreover, a viewpoint of an image of the avatar 40 displayed on the display unit 22 may be a viewpoint of an image seen from the avatar 40 (a so-called first-person viewpoint) and a viewpoint of an image overlooking the avatar 40 (a so-called third-person viewpoint). In this case, the control device 10 may switch a manipulation direction on the basis of a viewpoint of the image of the avatar 40 of the virtual space VS displayed on the display unit 22 so that the avatar 40 is moved forward when the distance between the camera 21 and the user 30 decreases in the case of a first-person viewpoint and the avatar 40 is moved backward when the distance between the camera 21 and the user 30 decreases in the case of a third-person viewpoint.

Moreover, when a plurality of users 30 are using the virtual space VS, a state in which the avatar 40-1 is moved by a manipulation of a first user (a user 30-1) may be reflected in the image within the virtual space VS in which another user 30 (e.g., a second user (a user 30-2), . . . , an n^{th} user (a user 30-n)) is visually recognized.

### Modified Example of Manipulation

Although the case where the forward or backward movement of the avatar 40 is controlled on the basis of the forward or backward movement of the face of the user 30 has been described, the present disclosure is not limited thereto. A modified example of the manipulation of the avatar 40 will be described with reference to FIGS. 17 to 32.

### [Rotation Movement]

The control device 10 may control the orientation of the avatar 40 around the avatar coordinate axis vz in accordance with the rotation around the real-space coordinate axis z of the face of the user 30.

FIG. 17 is a diagram showing an example of a relative positional relationship between the user 30 at the reference position and the camera 21.

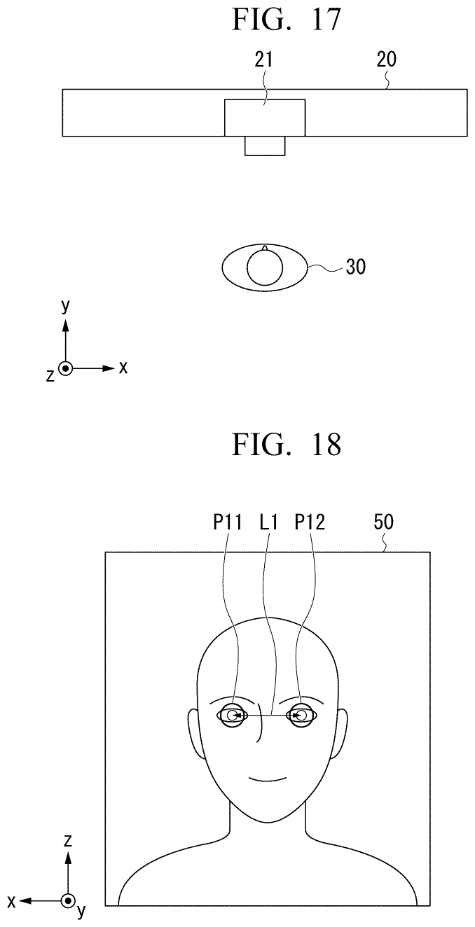

FIG. 18 is a diagram showing an example of a captured image 50 captured by the camera 21 of the user 30 at the reference position. In the captured image 50, the feature point P11 (right eye) and the feature point P12 (left eye) of the face of the user 30 are captured. When the user 30 is at the reference position, the distance between the feature point P11 and the feature point P12 is a distance L1 (i.e., a distance between the reference feature points).

FIG. 19 is a diagram showing an example of a result of movement control of the avatar 40 when the user 30 is at the reference position. When the user 30 is at the reference position, the avatar 40 in the virtual space VS faces the front (e.g., the + (plus) direction of the avatar coordinate axis vy).

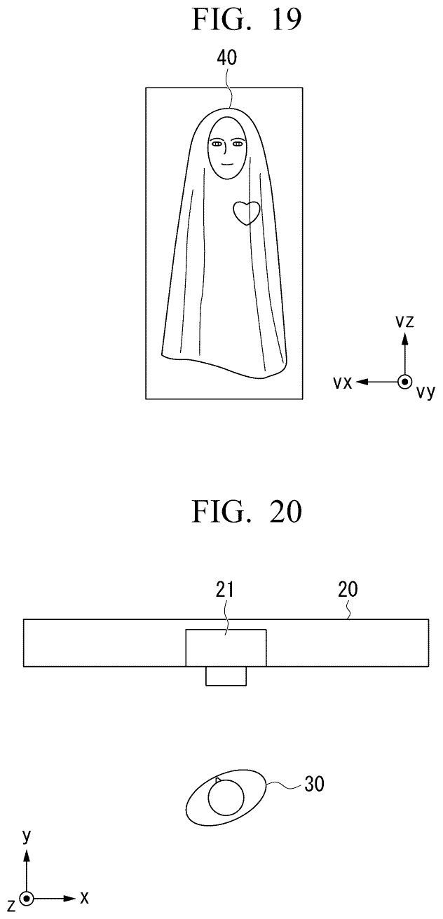

FIG. 20 is a diagram showing an example of a relative positional relationship between the user 30 and the camera 21 when the head is rotated in the left direction.

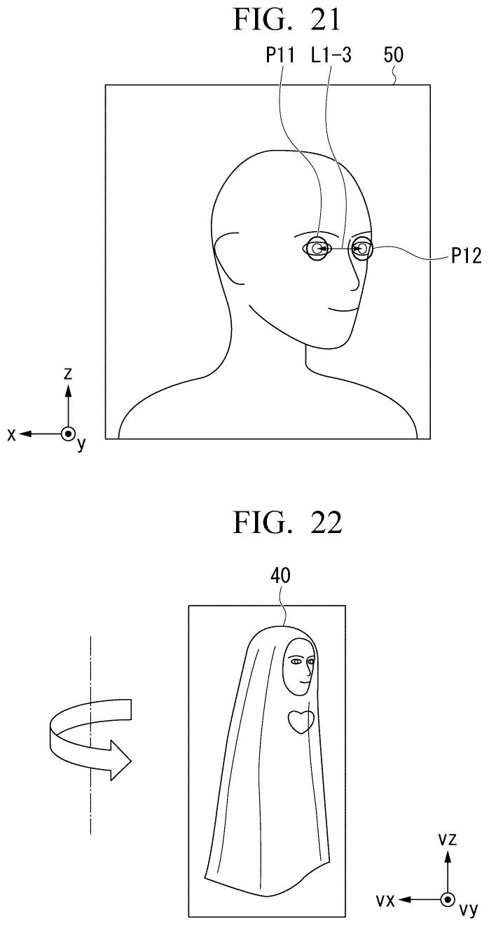

FIG. 21 is a diagram showing an example of a captured image 50 captured by the camera 21 of the user 30 whose head is rotated in the left direction. In the captured image 50, the feature point P11 (right eye) and the feature point P12 (left eye) of the face of the user 30 are captured. When the user 30 rotates the head in the left direction (i.e., counterclockwise when the real-space coordinate axis z is seen from above), a distance between the feature point P11 and the feature point P12 at the angle of view of the camera 21 is a distance L1-3. The distance L1-3 is less than the distance L1 (i.e., the reference distance) shown in FIG. 18. That is, when the head of the user 30 rotates around the real-space coordinate axis z, the distance between the feature point P11 and the feature point P12 decreases.

When it is detected that the distance between the feature point P11 and the feature point P12 has decreased, the posture information acquisition unit 133 determines that the head of the user 30 has rotated.

In addition, the posture information acquisition unit 133 may determine a rotation direction of the head of the user 30 by combining changes in positions of other feature points P (e.g., left and right cheekbones and a chin tip).

FIG. 22 is a diagram showing an example of a result of movement control of the avatar 40 when the head is rotated in the left direction. The movement control unit 134 changes the direction of the avatar 40 counterclockwise when the avatar coordinate axis vz is seen from above. That is, when the user 30 rotates the head in the left direction, the avatar also rotates in the left direction.

The control example of the case where the user 30 rotates the head in the left direction has been described. The control device 10 controls the avatar 40 in a similar way when the user 30 rotates his or her head in the right direction.

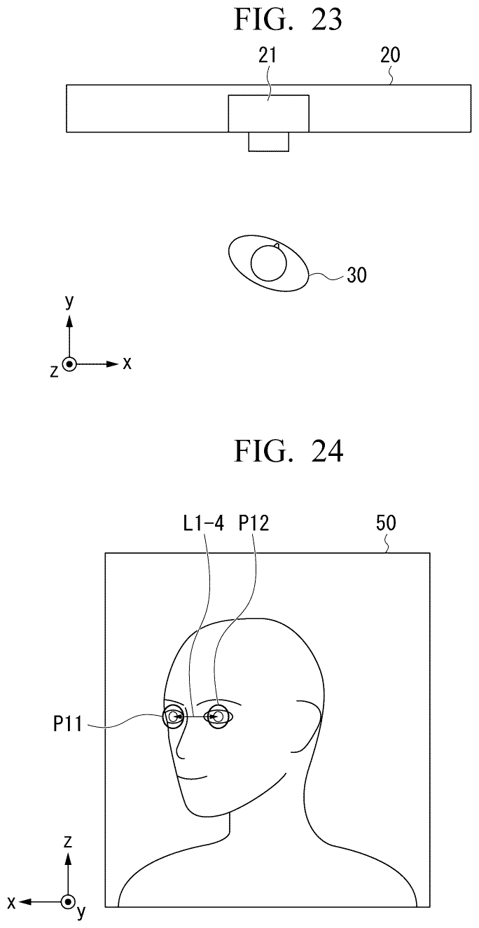

FIG. 23 is a diagram showing an example of a relative positional relationship between the user 30 and the camera 21 when the head is rotated in the right direction.

FIG. 24 is a diagram showing an example of a captured image 50 of the user 30 rotating the head in the right direction captured by the camera 21. When the user 30 rotates the head in the right direction (i.e., clockwise when the real space coordinate axis z is seen from above), a distance between the feature point P11 and the feature point P12 at the angle of view of the camera 21 is a distance L1-4. The distance L1-4 is less than the distance L1 (i.e., the reference distance) shown in FIG. 18.

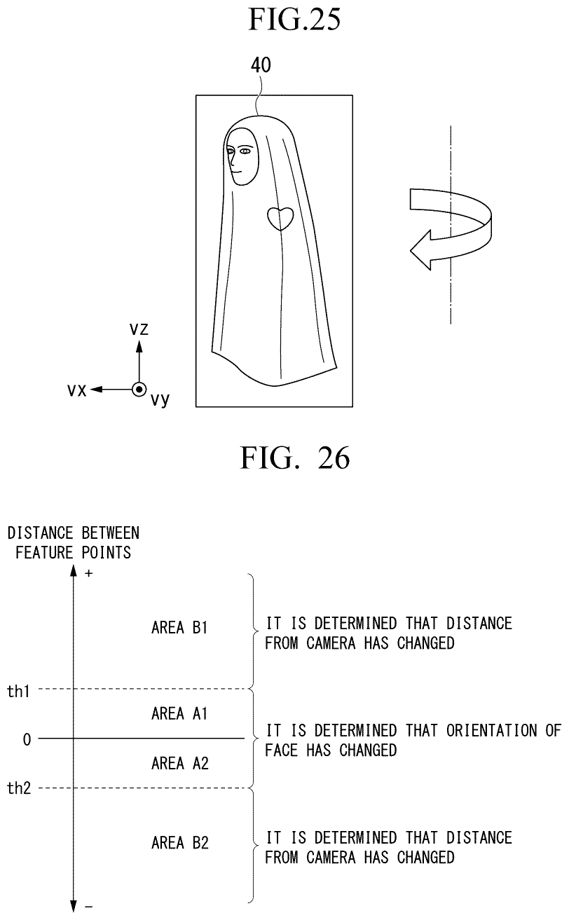

FIG. 25 is a diagram showing an example of a result of movement control of the avatar 40 when the head is rotated in the right direction. The movement control unit 134 changes the direction of the avatar 40 clockwise when the avatar coordinate axis vz is seen from above. That is, when the user 30 rotates his or her head in the right direction, the avatar 40 also rotates in the right direction.

Because a more specific control procedure is similar to a procedure in which the head is rotated in the left direction, description thereof will be omitted.

That is, the movement control unit 134 controls the direction of movement of the avatar 40 within the virtual space VS on the basis of the orientation of the face of the user 30 for the camera 21.

### [Control Based on Magnitude of Change in Distance Between Feature Points]

The movement control unit 134 may switch control on the basis of a magnitude of a change in a distance between the feature points P.

FIG. 26 is a diagram showing an example of control switching based on a magnitude of a change in distance between the feature points P. When the change in the distance between the feature points P is less than a threshold value th1 (i.e., a region A1) or less than a threshold value th2 (i.e., a region A2), the movement control unit 134 determines that a face orientation (a head orientation) of the user 30 has changed. Moreover, when the change in the distance between the feature points P is a threshold value th1 or larger (i.e., a region B1) or a threshold value th2 or larger (i.e., a region B2), the movement control unit 134 determines that the distance between the face of the user 30 and the camera 21 has changed.

That is, the movement control unit 134 controls the above-described rotational movement when the change in the distance between the feature points P is less than the threshold value th and controls the above-described forward or backward movement when the change in the distance between the feature points P is greater than or equal to the threshold value th.

### [Left or Right Movement Manipulation]

Control for moving the avatar 40 in the left or right direction on the basis of the operation of the user 30 tilting the head in the left or right direction will be described. The posture information acquisition unit 133 detects that the user 30 has tilted his or her head in the left or right direction when an angle formed by the vertical axis of the captured image 50 and a line segment connected between the feature points P exceeds a predetermined range.

FIG. 27 is a diagram showing an example of a captured image 50 of the user 30 tilting his or her head in the right direction captured by the camera 21. The posture information acquisition unit 133 detects that the user 30 has tilted his or her head in the right direction (i.e., counterclockwise when the real space coordinate axis y is seen from above).

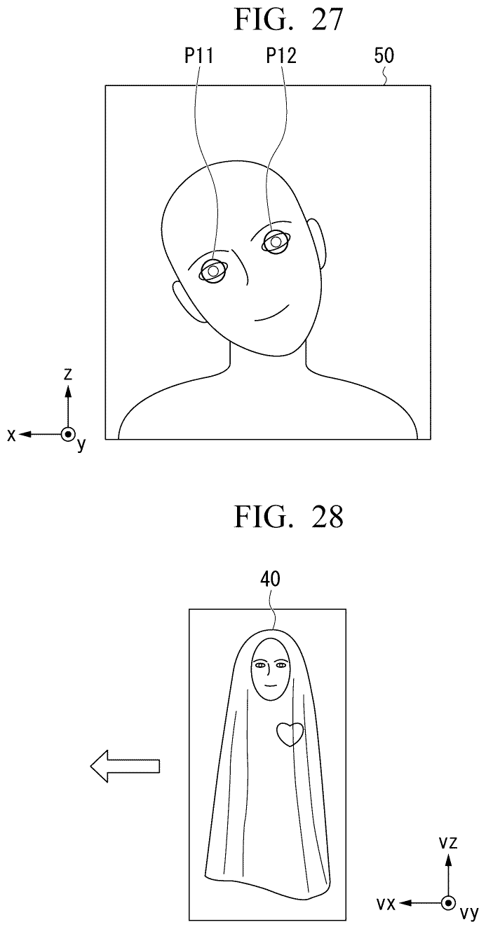

FIG. 28 is a diagram showing an example of a result of movement control of the avatar 40 when the head has tilted in the right direction. The movement control unit 134 causes the avatar 40 to move in the right direction (i.e., in the + (plus) direction of the avatar coordinate axis vx). That is, when the user 30 tilts his or her head in the right direction, the avatar 40 also moves in the right direction.

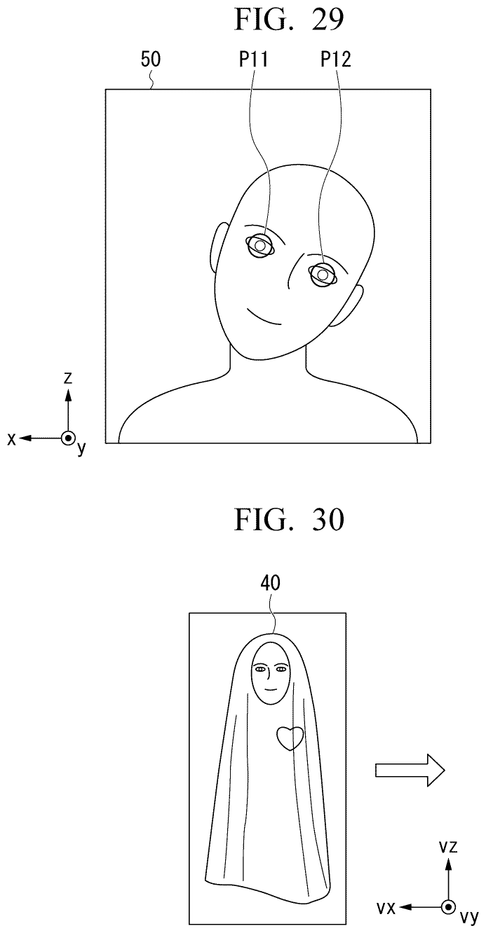

FIG. 29 is a diagram showing an example of a captured image 50 captured by the camera 21 of the user 30 tilting his or her head in the left direction. The posture information acquisition unit 133 detects that the user 30 has tilted his or her head in the left direction (i.e., clockwise when the real space coordinate axis y is seen from above).

FIG. 30 is a diagram showing an example of a result of movement control of the avatar 40 when the head is tilted in the left direction. The movement control unit 134 moves the avatar 40 in the left direction (i.e., in the − (minus) direction of the avatar coordinate axis vx). That is, when the user 30 tilts his or her head in the left direction, the avatar 40 also moves in the left direction.

That is, the movement control unit 134 controls the lateral movement of the avatar within the virtual space VS on the basis of a displacement direction from a reference posture of the face of the user 30.

### Movement Manipulation in Left or Right Direction (Modified Example)

The posture information acquisition unit 133 detects that the user 30 has moved in the left or right direction when the position of the face image 51 in the left or right direction is a predetermined distance away from a center line CL of the captured image 50.

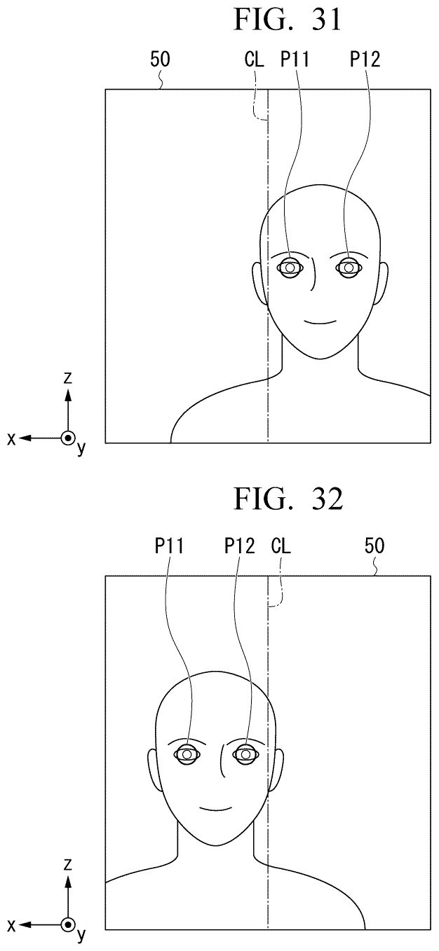

FIG. 31 is a diagram showing an example of a captured image 50 of the user 30 moving in the left direction captured by the camera 21. The posture information acquisition unit 133 detects that the user 30 has moved in the left direction (i.e., in the − (minus) direction of the real space coordinate axis x). In this case, the movement control unit 134 moves the avatar 40 in the left direction (i.e., in the − (minus) direction of the avatar coordinate axis vx).

FIG. 32 is a diagram showing an example of a captured image 50 of the user 30 moving in the right direction captured by the camera 21. The posture information acquisition unit 133 detects that the user 30 has moved in the right direction (i.e., in the + (plus) direction of the real space coordinate axis x). In this case, the movement control unit 134 moves the avatar 40 in the right direction (i.e., in the + (plus) direction of the avatar coordinate axis vx).

As described above, the avatar control system 1 of the present embodiment detects a manipulation intention of the user 30 by tracking the head and face of the user 30. According to the avatar control system 1 of the present embodiment, the movement of the avatar 40 within the virtual space VS can be controlled without using a wearable manipulation detection device, a hand-held controller, or the like.

Therefore, according to the avatar control system 1 of the present embodiment, conveniences for user who manipulate avatars within a metaverse (a virtual space) can be reduced.

In addition, the separation of the functions between the control device 10 (the avatar control device) and the terminal device 20 constituting the avatar control system 1 in the above-described embodiment is an example and is not limited to the example shown in FIG. 1. Although an example in which the control device 10 includes the initial setting information acquisition unit 132, a posture information acquisition unit 133, and a movement control unit 134 has been described, the present disclosure is not limited thereto. The terminal device 20 may include functions corresponding to the initial setting information acquisition unit 132, the posture information acquisition unit 133, and the movement control unit 134.

Although the embodiments of the present disclosure have been described above in detail with reference to the drawings, a specific configuration is not limited to these embodiments and design changes and the like may be included without departing from the spirit and scope of the present disclosure. Moreover, constituent elements shown in the above-described embodiments and modified examples can be appropriately combined and configured.

All or some functions provided in the parts provided in the avatar control system 1 according to the above-described embodiment may be implemented by recording a program for implementing these functions on a computer-readable recording medium and causing a computer system to read and execute the program recorded on the recording medium. In addition, the “computer system” used herein is assumed to include an operating system (OS) and hardware such as peripheral equipment.

Moreover, the “computer-readable recording medium” refers to a flexible disk, a magneto-optical disc, a read-only memory (ROM), a portable medium such as a compact disc-ROM (CD-ROM), or a storage device such as a hard disk embedded in the computer system. Furthermore, the “computer-readable recording medium” may include a computer-readable recording medium for dynamically holding the program for a short time period as in a communication line when the program is transmitted via a network such as the Internet or a communication circuit such as a telephone circuit and a computer-readable recording medium for holding the program for a given time period as in a volatile memory inside the computer system serving as a server or a client when the program is transmitted. Moreover, the above-described program may be a program for implementing some of the above-described functions. Furthermore, the above-described program may be a program capable of implementing the above-described function in combination with a program already recorded on the computer system.

### REFERENCE SIGNS LIST

1 Avatar control system
10 Control device
13 Control unit
20 Terminal device
30 User
40 Avatar
131 Image acquisition unit
132 Initial setting information acquisition unit
133 Posture information acquisition unit
134 Movement control unit
135 Image generation unit

1. An avatar control device for controlling an avatar to be displayed within a virtual space, wherein the avatar control device;
acquires a face image of a user captured by a camera;
acquires initial setting information indicating a reference posture of a face of the user;
acquires posture information indicating a posture of the face of the user for the camera on a basis of the face image;
controls forward or backward movement of the avatar within the virtual space on the basis of a distance between the camera and the face of the user indicated in the initial setting information and the posture information; and
controls a movement direction of the avatar within the virtual space on the basis of an orientation of the face of the user for the camera.

2. An avatar control device for controlling an avatar displayed as an alter ego of a user within a virtual space, wherein the avatar control device;
acquires a face image that is an image of a face of the user who visually recognizes an image of the virtual space displayed on a display unit, the image being captured by a camera;
acquires initial setting information indicating a reference posture of the face of the user;
acquires posture information indicating a posture of the face of the user for the camera on a basis of the face image; and
controls lateral movement of the avatar within the virtual space on the basis of a displacement angle from the reference posture of the face of the user indicated in the initial setting information and the posture information.

3. The avatar control device according to claim 1, wherein the avatar control device controls a forward or backward movement velocity or acceleration in accordance with a magnitude of a distance between the camera and the face of the user, or a change rate of the distance.

4. The avatar control device according to claim 1, wherein the avatar control device;
detects a predetermined operation of the user captured by the camera; and
prevents avatar movement control from being performed when the predetermined operation has been detected.

5. An avatar control method for controlling an avatar to be displayed within a virtual space, the avatar control method comprising:
acquiring a face image of a user captured by a camera;
acquiring initial setting information indicating a reference posture of a face of the user;
acquiring posture information indicating a posture of the face of the user for the camera on a basis of the face image;
controlling forward or backward movement of the avatar within the virtual space on the basis of a distance between the camera and the face of the user indicated in the initial setting information and the posture information; and
controlling a movement direction of the avatar within the virtual space on a basis of an orientation of the face of the user for the camera.
